(19) United States
(12) Patent Application Publication
(10) Pub. No.: US 2002/0019948 A1
(43) Pub. Date: Feb. 14, 2002

(54) Method and apparatus for preventing unauthorized intrusions into transmission apparatus maintenance system

(76) Inventors: Kouichi Katou, Touhaku (JP); Hiroshi Kanzawa, Kawasaki (JP)

Correspondence Address: Rosenman & Colin LLp, 575 Madison Avenue, New York, NY, 10022-2585, US

(21) Appl. No.: 09/952,509

(22) Filed: Sep. 12, 2001

Related U.S. Application Data
(63) Continuation of application No. PCT/JP00/09016, filed on Dec. 20, 2000.

(30) Foreign Application Priority Data
Apr. 5, 1999 (JP) 99/01800
Mar. 10, 2000 (JP) 2000-67051

(51) Int. Cl. H04L 12/22

(52) U.S. Cl. 713/202; 709/229

(57) ABSTRACT

When an unauthorized log-in is attempted from a maintenance terminal (18) physically connected to one of transmission apparatuses (20, 22, 23, 25, and 27), a log-in process block (34) incorporated in the transmission apparatus (for example, 25) on which the log-in has been attempted counts the number of attempted log-ins (60), and when the number of attempted log-ins reaches a predetermined number, a message reporting the occurrence of an unauthorized log-in attempt is sent to a monitoring terminal (28) for display thereon, together with the network addresses of the transmission apparatus (25) and the transmission apparatus (20) to which the maintenance terminal (18) is physically connected. A list of transmission apparatuses to which a command has been sent from the maintenance terminal (18) is stored in a remote apparatus connection field (62), and when disconnection of a cable of the maintenance terminal (18) is detected by a cable monitor (38), a log-out operation is forcefully performed on the transmission apparatus (20) and also on all the transmission apparatuses indicated in the list stored in the remote apparatus connection field (62).

### CROSS-REFERENCE TO RELATED APPLICATIONS

This application is a continuation of PCT/JP99/01800.

### TECHNICAL FIELD

The present invention relates to a method and apparatus for preventing unauthorized intrusions into a transmission apparatus maintenance system, and more particularly to a method and apparatus for preventing unauthorized intrusions into a maintenance system constructed in such a manner as to allow maintenance personnel to perform maintenance operations on any one of transmission apparatuses through a control channel from a maintenance terminal connected to one of the transmission apparatuses.

### BACKGROUND ART

To perform maintenance work on a transmission apparatus, maintenance personnel carry a maintenance terminal to the site where the transmission apparatus is installed, and carry out necessary maintenance by connecting the maintenance terminal to the transmission apparatus. In the case of test signal transmission, etc., the maintenance terminal is used to control not only the transmission apparatus to which the terminal is physically connected, but also the transmission apparatus installed at the remote end.

In this case, to protect the transmission apparatuses from illegal operations by persons not authorized to perform maintenance work, a security function using user ID and password is provided. More specifically, when performing maintenance work on the transmission apparatus to which the maintenance terminal is physically connected, the maintenance personnel cannot operate the transmission apparatus unless they log in to the transmission apparatus by entering a preregistered user ID and password from the maintenance terminal. In the case of the remote transmission apparatus also, the maintenance personnel cannot remotely operate the transmission apparatus at the remote end unless they log in to the remote transmission apparatus by transmitting a user ID and password from the transmission apparatus to which the maintenance terminal is physically connected.

Since user ID and password are a combination of characters, even an unauthorized user who does not know the password may eventually succeed in logging in if he or she makes repeated attempts by changing the combination. If such a situation were left unaddressed, authentication systems based on user ID and password would end up losing to unauthorized intrusions. In fact, apparatuses operating unattended would have to be left prone to illegal intrusions.

Moreover, if maintenance personnel forgot to perform the log-out procedure when leaving the site after finishing the work, a person who did not know the password could control the transmission apparatus without having to perform a log-in procedure.

### DISCLOSURE OF THE INVENTION

Accordingly, a first object of the invention is to prevent unauthorized intrusions that could occur if no actions were taken when repeated attempts were being made to break a user ID and password-based authentication system.

A second object of the invention is to prevent unauthorized intrusions that could occur if maintenance personnel forgot to log out after finishing maintenance work.

The first object is achieved by a method for preventing an unauthorized intrusion into a transmission apparatus maintenance system constructed in such a manner as to allow a user to perform maintenance operations on a transmission apparatus from a maintenance terminal by logging in to the transmission apparatus from the maintenance terminal, comprising the steps of: counting the number of failed log-ins to the transmission apparatus; sending a message to a monitoring terminal, when the number of failed log-ins exceeds a predetermined threshold value; and displaying the occurrence of an unauthorized log-in attempt on the monitoring terminal based on the message.

The second object is achieved by a method for preventing an unauthorized intrusion into a transmission apparatus maintenance system constructed in such a manner as to allow a user to perform maintenance operations on a transmission apparatus from a maintenance terminal by logging in to the transmission apparatus from the maintenance terminal, comprising the steps of: monitoring a physical connection to the maintenance terminal; and forcefully causing the user to log out when disconnection of the physical connection to the maintenance terminal is detected.

The first object is also achieved by an apparatus for preventing an unauthorized intrusion into a transmission apparatus maintenance system constructed in such a manner as to allow a user to perform maintenance operations on a transmission apparatus from a maintenance terminal by logging in to the transmission apparatus from the maintenance terminal, comprising: means for counting the number of failed log-ins to the transmission apparatus; and means for sending a message to a monitoring terminal when the number of failed log-ins exceeds a predetermined threshold value, the message being used to display the occurrence of an unauthorized log-in attempt on the monitoring terminal.

The second object is also achieved by an apparatus for preventing an unauthorized intrusion into a transmission apparatus maintenance system constructed in such a manner as to allow a user to perform maintenance operations on a transmission apparatus from a maintenance terminal by logging in to the transmission apparatus from the maintenance terminal, comprising: means for monitoring a physical connection to the maintenance terminal; and means for forcefully causing the user to log out when disconnection of the physical connection to the maintenance terminal is detected.

### BRIEF DESCRIPTION OF THE DRAWINGS

FIG. 1 is a diagram showing one example of a communication system to which the present invention is applied;

FIG. 2 is a block diagram showing the configuration of a transmission apparatus according to the present invention;

FIG. 3 is a block diagram showing the details of the transmission apparatus according to the present invention;

FIG. 4 is a diagram showing an overview of processing performed in response to a command entered by a user;

FIG. 5 is a diagram showing the format of the command which a maintenance terminal issues;

FIG. 6 is a diagram showing the command converted into the format for internal processing;

FIG. 7 is a diagram showing an example of a network address;

FIG. 8 is a flowchart illustrating the details of a delivery process;

FIG. 9 is a flowchart illustrating the details of a control process;

FIG. 10 is a flowchart illustrating the details of a log-in process;

FIG. 11 is a flowchart illustrating the details of a log-out process;

FIG. 12 is a flowchart illustrating the details of a cable monitoring process; and

FIG. 13 is a diagram showing a cable connection status register.

### BEST MODE FOR CARRYING OUT THE INVENTION

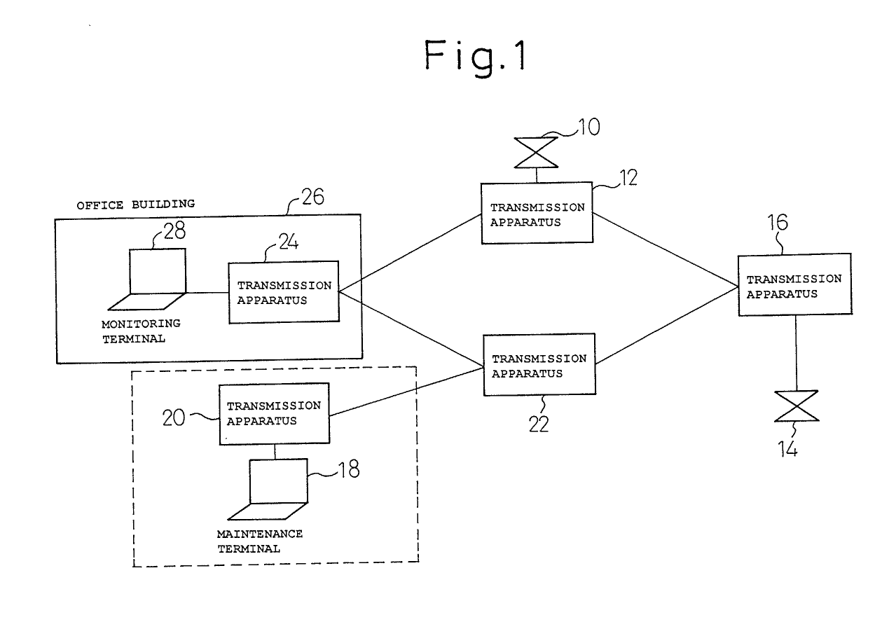

FIG. 1 shows one example of a communication system to which the present invention is applied. In FIG. 1, a maintenance network is constructed with a transmission apparatus 12 connected to an exchange 10, a transmission apparatus 16 connected to an exchange 14, a transmission apparatus 20 to which a maintenance terminal 18 is connected, a transmission apparatus 22, and a transmission apparatus 24. The transmission apparatus 24 is installed within an office building 26, and a monitoring terminal 28 is connected to it. Usually, information such as fault information concerning each transmission apparatus is displayed on the monitoring terminal 28. A maintenance engineer enters a preassigned user ID and password from the maintenance terminal 18 and logs in to the transmission apparatus 20 so that he or she can control the transmission apparatus 20 by operating the maintenance terminal 18. By logging in to another transmission apparatus 12, 16, 22, or 24 from the maintenance terminal 18 via the transmission apparatus 20, the maintenance engineer can also control the transmission apparatus at a remote site by using the maintenance terminal 18.

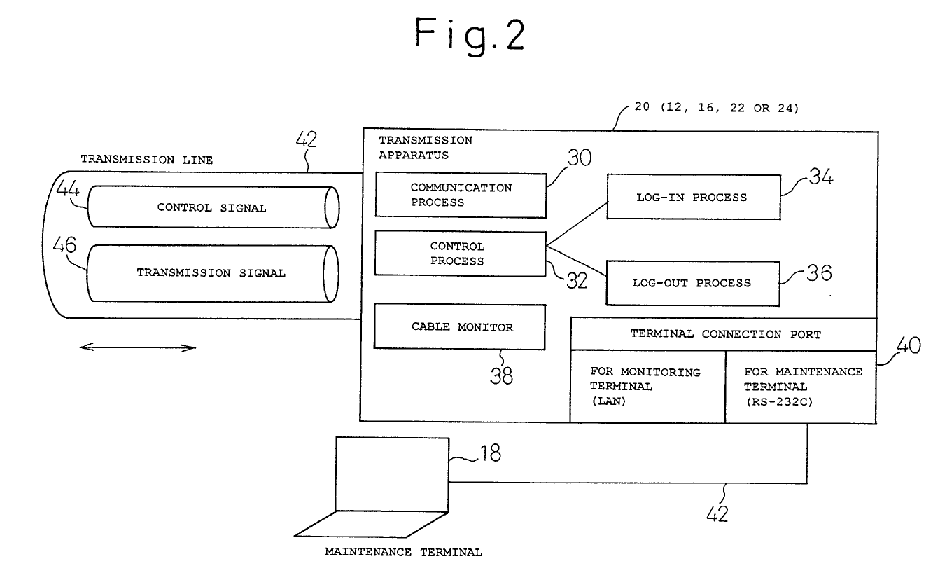

FIG. 2 shows the configuration of the transmission apparatus 20 (12, 16, 22, or 24) according to the present invention. The transmission apparatus 20 includes software process blocks 30, 32, 34, 36, and 38, and a connection port 40 for connecting a connecting cable. A transmission line 42 carries a control signal 44 and a transmission signal 46. The control signal 44 carries a command used to control a remotely located transmission apparatus from the maintenance terminal 18 and monitoring terminal 28. Simply by installing the transmission line as shown in FIG. 1, it becomes possible to control a remotely located transmission apparatus by using the control signal 44.

The communication process block 30 is responsible for the transfer of the control signal 44 on the transmission line 42 and communications between the monitoring terminal 28 and the maintenance terminal 18. This process block also has the function of storing the network addresses of all the transmission apparatuses that have been accessed.

The control process block 32 diverts processing to the corresponding process block under the control of the communication process block 30.

The log-in process block 34 verifies a log-in by checking the user ID and password. It also counts the number of log-in errors and sends an alarm to the monitoring terminal 28.

The log-out process block 36 is responsible for user log-out.

The cable monitor 38 monitors whether the cable 43 connecting the transmission apparatus 20 and the maintenance terminal 18 is connected or disconnected. If the cable is disconnected, control is performed so that the user who has logged in from the maintenance terminal is caused to log out from all the transmission apparatuses.

In the present invention, the log-in process block 34 detects an unauthorized intrusion attempt by counting the number of erroneous entries of the user ID and password, and notifies the monitoring terminal 28. Further, the cable monitor 38 detects disconnection of the connecting cable 43 connected to the maintenance terminal 18, and when disconnection is detected, log-out control is performed for all the transmission apparatuses that have been controlled from the maintenance terminal 18. With this control, if the maintenance personnel forgot to log out, log-out is performed autonomously.

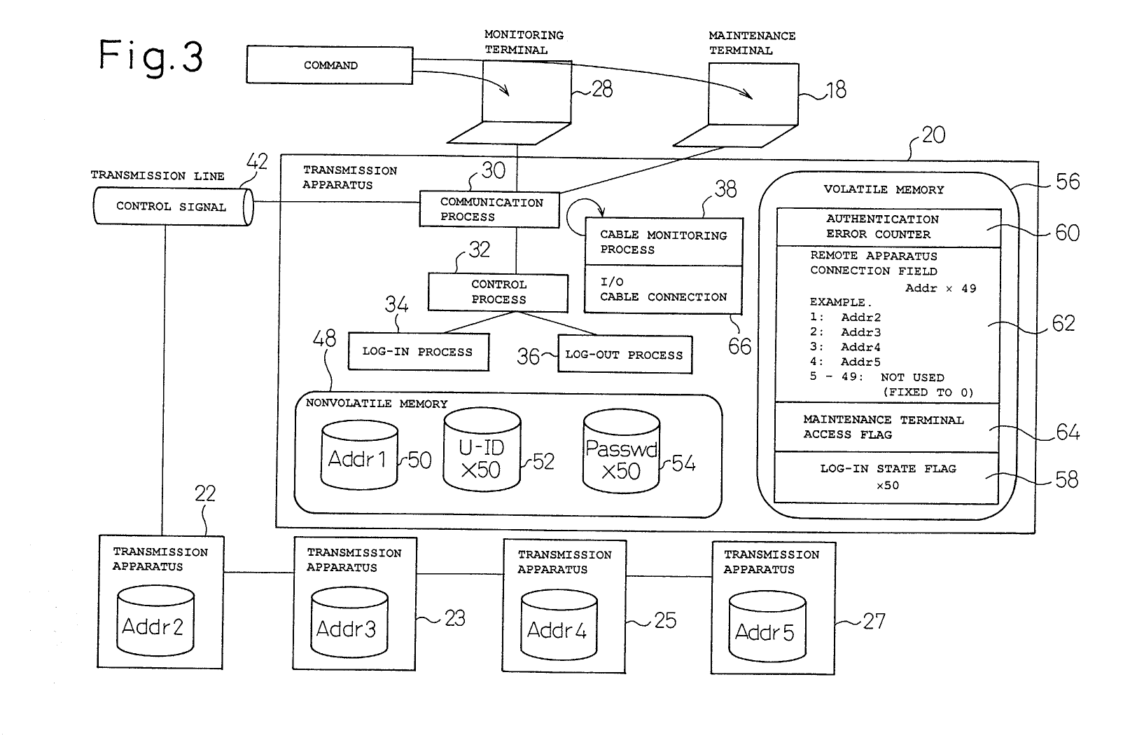

FIG. 3 shows the details of the transmission apparatus 20 of FIG. 2. The same constituent elements as those in FIG. 2 are designated by the same reference numerals. AS in prior known security systems, a network address 50 (designated as Addr only in this figure), a user ID 52 (designated as U-ID only in this figure), and a password 54 (designated as Passwd only in this figure) are stored as nonvolatile information 48, while a log-in state flag 58 indicating the user that has logged in to the transmission apparatus 20 is stored as volatile information 56. This transmission apparatus can store 50 user IDs 52 and their associated passwords and 50 log-in state flags, so that up to 50 users can be registered. The only data table added in carrying out the present invention is the volatile information 56, and the added elements are an authentication error counter 60 for detecting unauthorized intrusions being attempted by searching for user IDs and passwords, a remote apparatus connection field 62 for storing the network addresses of transmission apparatuses remotely connected from the maintenance terminal directly attached to the transmission apparatus, and a maintenance terminal access flag 64 which remembers whether an access has been made from the maintenance terminal. There is also added a register 66 as a hardware I/O for indicating cable connection status.

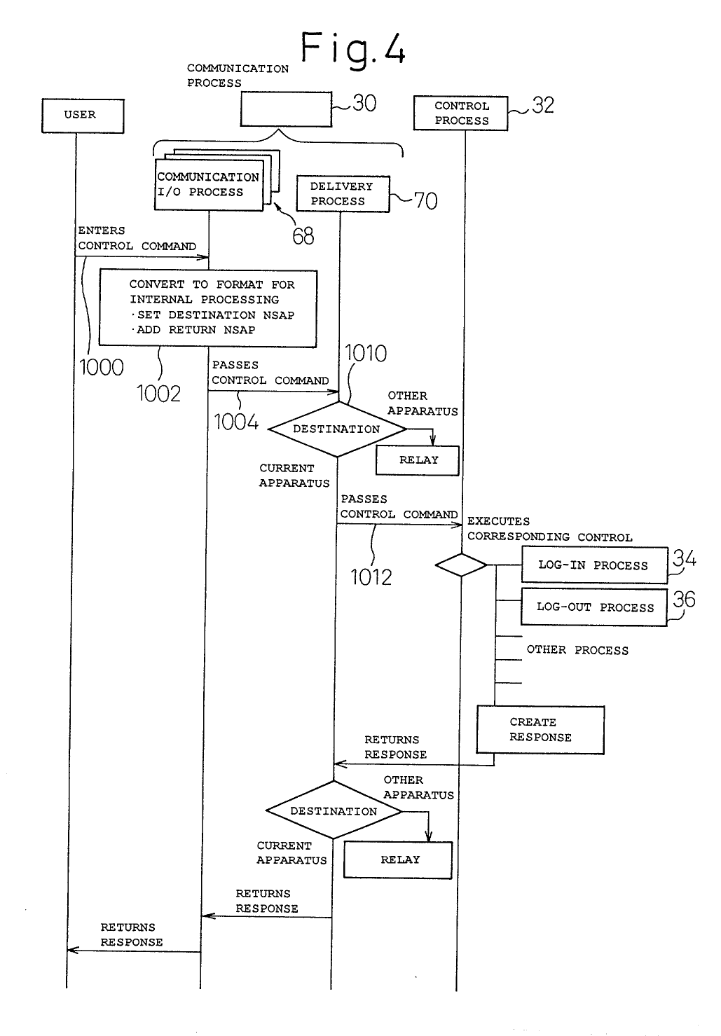

FIG. 4 shows an overview of the processing performed in response to a user command entered from the maintenance terminal 18 or the monitoring terminal 28.

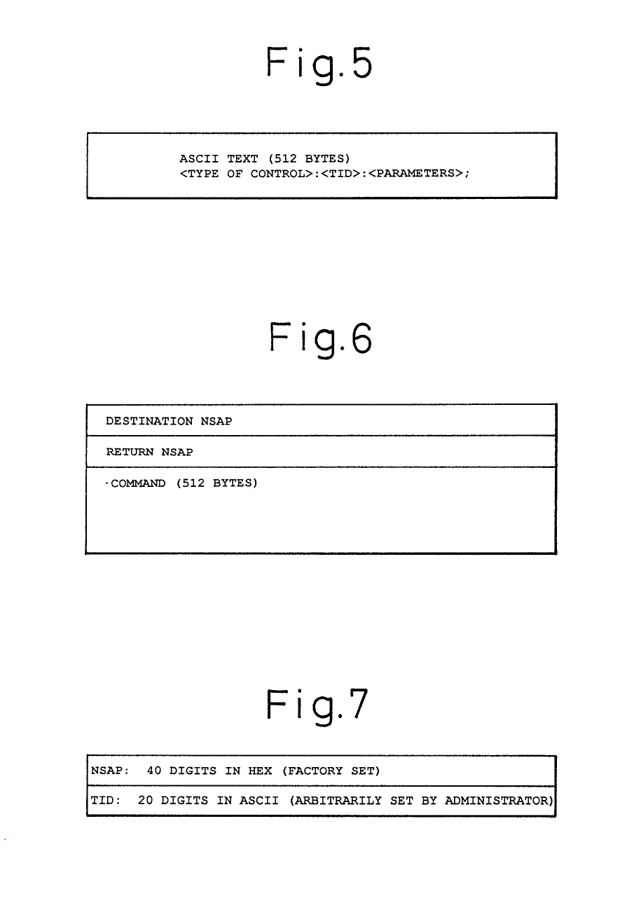

In FIG. 4, the maintenance terminal issues a command of the format shown in FIG. 5 in response to the user operation (step 1000). Within the transmission apparatus, the command is processed by attaching a destination address and return network address for internal processing, as shown in FIG. 6 (step 1002).

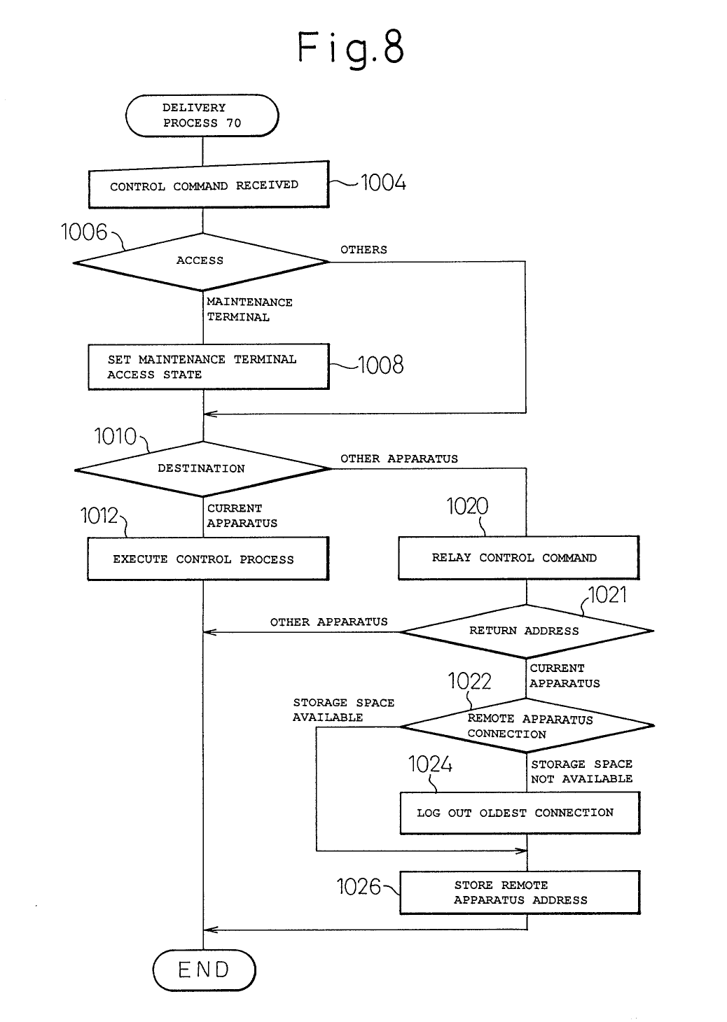

In this transmission apparatus, two types of network address are provided, as shown in FIG. 7. One is NSAP (Network Service Access Point), and the other is TID (Target ID). Both are processed as nonvolatile data, but the NSAP is set at the factory and cannot be altered at the user's discretion. Therefore, the TID is provided as the network address that the user can set as desired. The maintenance or monitoring personnel perform work by identifying the control target transmission apparatus by using the TID which serves as an alias of the transmission apparatus. Conventionally, TIDs and NSAPs are always transferred between transmission apparatuses for communication processing, and a database capable of converting the address to either address type is provided. Communication software installed in the monitoring terminal 28 can communicate with the transmission apparatus by using the NSAP that matches the address type used in the transmission apparatus. The NSAP is the network address type used when communicating with the monitoring terminal or when it is necessary to transmit binary data. TID is not assigned to the monitoring terminal 28.

Every command, whether it is entered from the maintenance terminal 18 or from the monitoring terminal 28, is processed in the communication process block 30. In order to accommodate physically different communication devices, i.e., RS-232C for the maintenance terminal 18, LAN for the monitoring terminal 28, and transmission line 42 for the control signal, the communication process block 30 includes, as shown in FIG. 4, a plurality of communication I/O processes 68 corresponding to the respective communication devices, and a delivery process 70 which consolidate them. In the case of a command from the maintenance terminal 18, the NSAP of the destination is determined from the TID contained in the command (FIG. 5), and the destination NSAP and the return NSAP, i.e, the NSAP of the current apparatus, are set in accordance with the format of FIG. 6 (step 1002). The control command converted to the format of FIG. 6 is passed to the delivery process 70 (step 1004).

FIG. 8 shows the details of the delivery process 70. As shown in FIG. 8, when an access is made from the maintenance terminal (step 1006), the maintenance terminal access flag 64 (FIG. 3) is set to indicate that an access has been made from the maintenance terminal (step 1008). This enables the cable monitor described later, and in the event of a cable disconnection, connections to all apparatuses are released.

Next, the destination address is compared with the network address of the current apparatus (step 1010), to determine whether the command is to be relayed or not. In the example of FIG. 3, a command sent from the maintenance terminal 18 to the transmission apparatus 25 is relayed via the transmission apparatuses 20, 22, and 23 to the transmission apparatus 25. In the apparatus of the invention, when delivering a command, there is no need to log in to the apparatus to which the terminal is connected, but the command is delivered based on the destination network address contained in the command. Usually, in the case of a workstation or a personal computer, security is designed so that a connection cannot be made to other apparatuses if a log-in cannot be made to the workstation or personal computer itself, but this is not the case with the transmission apparatus.

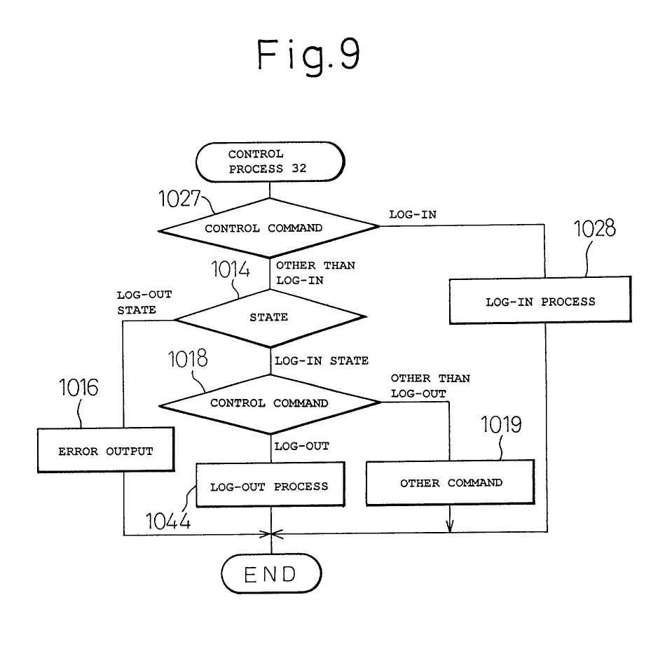

The command that matches the network address of the receiving apparatus is passed on to the control process block 32 (step 1012). As illustrated in detail in FIG. 9, the control process block 32 initiates the processing corresponding to the control type of the command. In the control process, the log-in state flag is checked to determine whether the current state is a log-in state or not (step 1014), and if the state is not a log-in state, it is treated as an error and no control other than the log-in process is performed (step 1016). In this way, the transmission apparatus cannot be controlled unless the log-in is completed. On the other hand, if the state is a log-in state, control commands other than the log-in are enabled (steps 1018, 1019, and 1044) so that the transmission apparatus can be controlled.

Turning back to FIG. 8, if the command does not match the network address of the receiving apparatus, the command is forwarded to another transmission apparatus (step 1020). In the present invention, if disconnection of the cable of the maintenance terminal is detected in the cable monitoring process, control is performed to forcefully cause the user to log out from all the transmission apparatuses to which the user has logged in from the maintenance terminal; for this purpose, the addresses of all the transmission apparatuses remotely connected are stored (step 1026). In carrying out the present invention, the number of transmission apparatuses that can be logged in to simultaneously from one maintenance terminal must be limited. If the number exceeds 49, which is the maximum number of connections that the apparatus can store (step 1022), the oldest connection is logged out (step 1024) to make room for a new connection. This limitation does not apply to the monitoring terminal. This is because the monitoring terminal communicates independently by using a NSAP different from that of the transmission apparatus to which the monitoring terminal is connected, so that the return address is not the address of the transmission apparatus. The maximum number of 49 in this embodiment is sufficient for practical purposes. To describe the above process in more detail, after relaying the control command (step 1020), if the return address of the relayed command matches the address of the current apparatus (step 1021), the number of connections stored therein is examined by referring to the remote apparatus connection field 62 (FIG. 3). If the number reaches the upper limit, the oldest connection is logged out (step 1024), and the address of the destination apparatus is stored (step 1026). The “connection” here does not mean a physical connection, but refers to the state in which a remote connection has been set up or the exchange of a command and a response has been performed, i.e. log-in to that apparatus has obviously been completed.

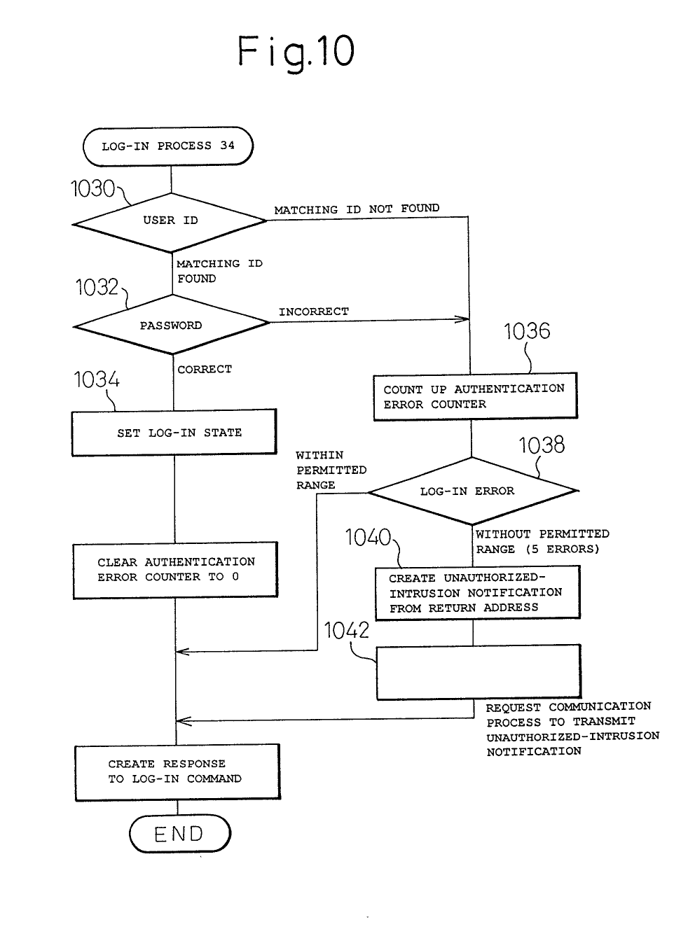

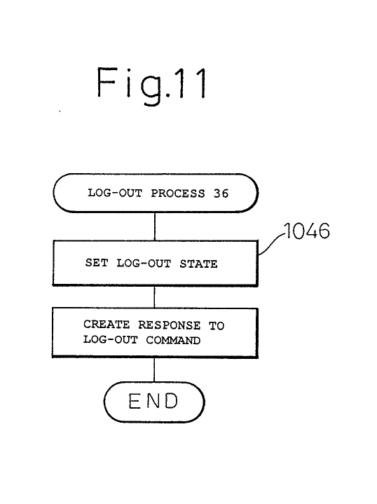

If the command is a log-in command (step 1027), the log-in process block 34 is activated (step 1028 in FIG. 9). The log-in process is illustrated in detail in FIG. 10. In the log-in process, it is determined whether the user ID and password specified in the parameters of the command are correct or not (steps 1030 and 1032) by referring to the combination of characters, i.e. the user ID and password, stored in the nonvolatile storage area, and it is determined whether or not the log-in state flag is to be set to the log-in state (step 1034). The process up to this point is the same as that in the prior known security system. However, in the present invention, the following additional steps are carried out. The number of log-in command errors is counted by the authentication error counter (step 1036), and if the number exceeds the preset value 5, it is determined that an unauthorized intrusion has been attempted (step 1038), in which case, an alarm is reported to the monitoring personnel (monitoring terminal 28) (steps 1040 and 1042). The alarm notification includes an indication of an unauthorized intrusion attempt, the TID of the current apparatus, i.e. the apparatus on which the unauthorized intrusion has been attempted, and the NSAP and TID of the transmission apparatus specified by the return network address, which indicate the transmission apparatus physically connected to the maintenance terminal on which the unauthorized intrusion is being attempted. If the command is a log-out command, the control process block 32 activates the corresponding log-out process block 36 (step 1044) as shown in the flow of the control process block 32 of FIG. 9. In the log-out process, the log-in state flag 58 is set to the log-out state (step 1046) as shown in the flow of the log-out process of FIG. 11. In the present invention, in order that the log-out process can be performed autonomously, no complicated decision procedures are involved, and only the log-out is executed, eliminating the need for retries and other operations.

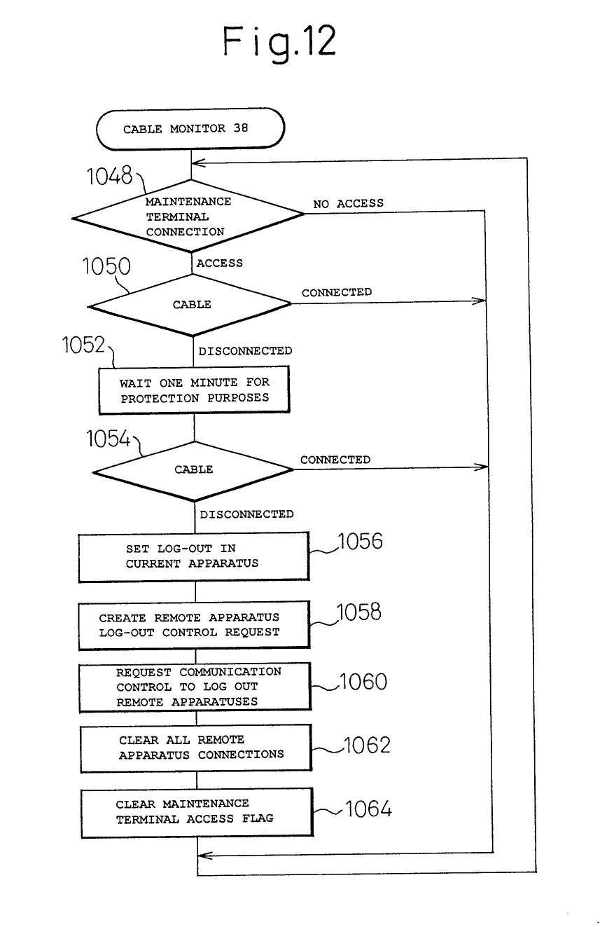

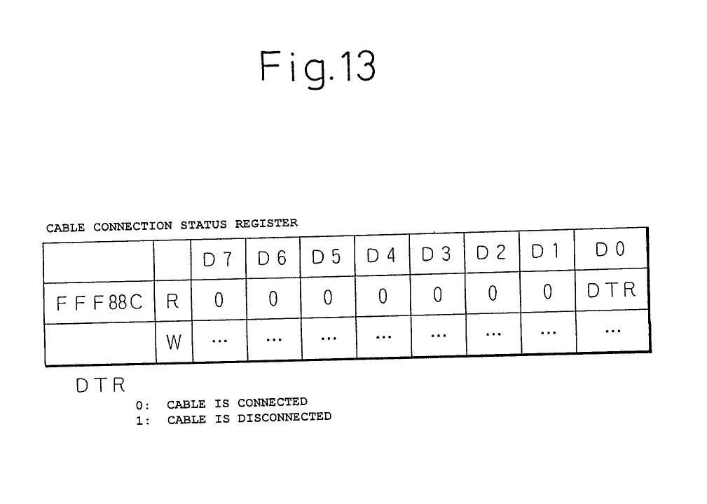

FIG. 12 shows the details of the cable monitor 38. The cable monitoring process is activated when the transmission apparatus is powered up, and the process is repeated endlessly. First, in step 1048, the maintenance terminal access flag 64 is examined to see whether the flag is set or not. As described in step 1008 in FIG. 8, the maintenance terminal access flag is not set until a control command is received from the maintenance terminal physically connected to the transmission apparatus; therefore, as long as the flag is not set, the cable monitoring process does nothing. If the maintenance terminal access flag is set, then a DTR (Data Terminal Ready) bit in the cable connection status register 66 (FIG. 3), whose contents are shown in FIG. 13, is examined to see whether the cable is disconnected or not (step 1050). When the maintenance terminal is physically connected, the DTR bit is set to 0 since a voltage indicating READY is output on the DTR signal line from the maintenance terminal, but when the cable is disconnected, the DTR bit becomes 1. If disconnection of the cable is detected with DTR bit=1, for protection purposes the process waits one minute (step 1052), and the DTR bit is examined once again (step 1054). If the DTR bit remains at 1, the log-out state is set in the current apparatus, i.e. the transmission apparatus to which the maintenance terminal was directly (physically) connected (step 1056). Further, using the remote apparatus connections 62 created in the communication process block 30, a log-out request is issued to all the remotely connected transmission apparatuses to clear the log-ins established to all the transmission apparatuses which were being controlled from the maintenance terminal (steps 1058 and 1060). Since all the remote connections are released by the above operation, the remote apparatus connections 62 and the maintenance terminal access flag 64 are cleared (steps 1062 and 1064).

With the above-described operations, the unauthorized intrusion prevention described below is accomplished.

### DETECTION AND NOTIFICATION OF UNAUTHORIZED INTRUSION ATTEMPT

In the present invention, functions for the detection and notification of an unauthorized intrusion attempt are added to the prior art log-in process. To detect whether an unauthorized intrusion attempt is being made, the number of log-in failures is counted, as shown in the flow of the log-in process block 34 of FIG. 10. If the number exceeds the preset number, it is determined that the attempted log-in is an unauthorized intrusion attempt, and the monitoring personnel are notified immediately. The monitoring personnel can thus take proper measures based on the TID of the transmission apparatus on which the unauthorized intrusion attempt has been detected and on the network address of the transmission apparatus physically connected to the terminal on which the unauthorized intrusion is being attempted.

Referring to FIG. 3, assume that an unauthorized intrusion into the transmission apparatus 20 is being repeatedly attempted using the maintenance terminal 18, on which a search for combination patterns of the user ID and password is being made and causing log-in command errors many times. When the number of authentication errors exceeds the permitted number, the transmission apparatus 20 then reports its own TID and the return network address to the monitoring personnel. In this example, since the return network address is the same as the address of the transmission apparatus 20, the alarm is sent to the monitoring terminal 28 by appending the NSAP and TID of the transmission apparatus 20. On the other hand, in the case where the transmission apparatus 20 is being used to attempt an unauthorized intrusion into the transmission apparatus 22, the TID of the transmission apparatus 22 that detected the unauthorized intrusion and the return network address are reported to the monitoring personnel. In this example, since the return network address is the address of the transmission apparatus 20 to which the maintenance terminal 18 is connected, the alarm is sent to the monitoring terminal 28 by appending the TID and NSAP of the transmission apparatus 20. In this way, if a log-in is attempted on any transmission apparatus, the return network address indicates the transmission apparatus 20 if the maintenance terminal being used to attempt the unauthorized intrusion is connected to the transmission apparatus 20; thus, the transmission apparatus from which the unauthorized intrusion is being attempted can be identified.

In the present invention, both TID and NSAP are included in the unauthorized-intrusion notification. This takes into consideration those monitoring terminals, etc. that use only NSAP for communication. For example, in FIG. 3, if an unauthorized intrusion is attempted on the transmission apparatus 18 from the monitoring terminal 28 (though this normally cannot happen), the transmission apparatus 18 reports its own TID and the NSAP of the monitoring terminal 28 specified by the return network address. Since the monitoring terminal 28 does not have a TID, data indicating the absence of the TID is output as the TID. Such a situation cannot happen under normal operating conditions, but in case this should happen, provisions are made to output both TID and NSAP.

### PREVENTION OF LOG-OUT FAILURE BY MAINTENANCE PERSONNEL

In the present invention, since the maintenance personnel carry the terminal around, when disconnection of the connecting cable of the maintenance terminal is detected, a log-out request is sent to all the transmission apparatuses to which the maintenance personnel have logged in, thereby preventing an unauthorized intrusion. As shown in the flowchart of FIG. 12, the cable monitor 38 constantly monitors the cable of the maintenance terminal for a disconnection, and when a cable disconnection is detected, a log-out command is created and sent to all the connected transmission apparatuses. As shown in the flowchart of FIG. 8, the network addresses of all the transmission apparatuses to which a command has been delivered from the maintenance terminal are stored to create a list of transmission apparatuses to which the maintenance personnel have logged in.

In FIG. 3, when the transmission apparatuses 20, 22, 23, 25, and 27 are being controlled from the maintenance terminal 18, the network addresses (Addr 2 to 5) of the transmission apparatuses 22, 23, 25, and 27 are stored in the remote apparatus connection field in the communication process. When maintenance work is finished, the maintenance personnel disconnect the connecting cable and carry away the maintenance terminal. This condition is monitored by the cable monitor 38, and a log-out is performed to release the remote connections established to the transmission apparatuses 22, 23, 25, and 27, as well as the connection to the apparatus 20 to which the maintenance terminal was connected.

1. A method for preventing an unauthorized intrusion into a transmission apparatus maintenance system constructed in such a manner as to allow a user to perform maintenance operations on a transmission apparatus from a maintenance terminal by logging in to said transmission apparatus from said maintenance terminal, said method comprising the steps of:
counting the number of failed log-ins to said transmission apparatus;
sending a message to a monitoring terminal when the number of failed log-ins exceeds a predetermined threshold value; and
displaying the occurrence of an unauthorized log-in attempt on said monitoring terminal, based on said message.

2. A method according to claim 1, wherein
said maintenance system is constructed so that from the maintenance terminal physically connected to one of a plurality of transmission apparatuses, a log-in can be made to said one transmission apparatus or to any one of the other transmission apparatuses,
at each of said plurality of transmission apparatuses, the number of failed log-ins to itself is counted,
said message includes an identifier identifying the transmission apparatus on which the log-in was attempted, and an identifier identifying the transmission apparatus to which the maintenance terminal that attempted the log-in is connected, and
the display produced on said monitoring terminal includes indication of the transmission apparatus on which the log-in was attempted and indication of the transmission apparatus to which the maintenance terminal used to attempt the log-in is physically connected.

3. A method for preventing an unauthorized intrusion into a transmission apparatus maintenance system constructed in such a manner as to allow a user to perform maintenance operations on a transmission apparatus from a maintenance terminal by logging in to said transmission apparatus from said maintenance terminal, said method comprising the steps of:
monitoring a physical connection to said maintenance terminal; and
forcefully causing said user to log out when disconnection of the physical connection to said maintenance terminal is detected.

4. A method according to claim 1, wherein
said maintenance system is constructed so that from the maintenance terminal physically connected to one of a plurality of transmission apparatuses, a log-in can be made to said one transmission apparatus or to any one of the other transmission apparatuses, said method further comprising the step of:
storing, at each of said plurality of transmission apparatuses, a list of transmission apparatuses to which a command has been sent from the maintenance terminal connected to itself, and wherein:
when disconnection of the physical connection to said maintenance terminal is detected, said user is forcefully caused to log out from all the transmission apparatuses indicated in said stored list.

5. An apparatus for preventing an unauthorized intrusion into a transmission apparatus maintenance system constructed in such a manner as to allow a user to perform maintenance operations on a transmission apparatus from a maintenance terminal by logging in to said transmission apparatus from said maintenance terminal, said apparatus comprising:
means for counting the number of failed log-ins to said transmission apparatus; and
means for sending a message to a monitoring terminal when the number of failed log-ins exceeds a predetermined threshold value, said message being used to display the occurrence of an unauthorized log-in attempt on said monitoring terminal.

6. An apparatus according to claim 5, wherein
said maintenance system is constructed so that from the maintenance terminal physically connected to one of a plurality of transmission apparatuses, a log-in can be made to said one transmission apparatus or to any one of the other transmission apparatuses, and
said message includes an identifier identifying the transmission apparatus originating said message, and an identifier identifying the transmission apparatus to which the maintenance terminal used to attempt the log-in is physically connected.

7. An apparatus for preventing an unauthorized intrusion into a transmission apparatus maintenance system constructed in such a manner as to allow a user to perform maintenance operations on a transmission apparatus from a maintenance terminal by logging in to said transmission apparatus from said maintenance terminal, said apparatus comprising:
means for monitoring a physical connection to said maintenance terminal; and
means for forcefully causing said user to log out when disconnection of the physical connection to said maintenance terminal is detected.

8. An apparatus according to claim 7, wherein
said maintenance system is constructed so that from the maintenance terminal physically connected to one of a plurality of transmission apparatuses, a log-in can be made to said one transmission apparatus or to any one of the other transmission apparatuses, said apparatus further comprising:
means for storing a list of transmission apparatuses to which a command has been sent from the maintenance terminal connected to itself, and wherein:
when disconnection of the physical connection to said maintenance terminal is detected, said user is forcefully caused to log out from all the transmission apparatuses indicated in said stored list.
